(19) United States
(12) Patent Application Publication
(10) Pub. No.: US 2020/0055428 A1
(43) Pub. Date: Feb. 20, 2020

(54) Vehicle seat

(71) Applicant: TACHI-S ENGINEERING U.S.A., INCORPORATED, Farmington Hills, MI (US)

(72) Inventors: Yasuo Kakishima, Farmington Hills, MI (US); Rengith Francis Xavier, Farmington Hills, MI (US); Anand Abraham, Farmington Hills, MI (US); Richard Entrup, Farmington Hills, MI (US)

(21) Appl. No.: 15/999,026

(22) Filed: Aug. 20, 2018

(51) Int. Cl. B60N 2/30; B60N 2/12; B60N 2/28; B60N 2/50

(52) U.S. Cl. CPC B60N 2/3011; B60N 2/12; B60N 2002/0216; B60N 2/50; B60N 2/28

(57) ABSTRACT

A vehicle seat is provided with a seat sliding mechanism (a) including a lower rail and an upper rail fitted and moved in the lower rail, a seat structure (b) equipped with a seat cushion frame including a seat side member and a seat back frame, an upper riser (c) fixed to the upper rail and supporting the seat structure, and a seat inclining mechanism (d) that enables inclining of the seat structure for the upper riser. When the seat structure is inclined by the seat inclining mechanism, an angle between the seat cushion frame and the seat back frame is maintained and the rear of the seat cushion frame is located on the upside of the rear of the seat cushion frame in a state before the seat structure is inclined by the seat inclining mechanism.

### BACKGROUND

This disclosure relates to a vehicle seat and for example, this disclosure can be applied to a vehicle seat equipped with a child safety seat.

To enhance ease of egress and ingress from/onto a back row seat arranged on the back side and extend cargo room space, a vehicle seat for enabling forward movement and tuning is utilized.

### SUMMARY

However, as turning of a seat back is obstructed when a child safety seat and others exist on a seat, accessibility to the back row seat or extension of the cargo room space is also deteriorated.

An object of this disclosure is to provide a vehicle seat that enables enhancing accessibility to a back row seat or extending cargo room space.

Other objects and new characteristics will be clarified from description of this disclosure and attached drawings.

Brief description of an outline of a representative of this disclosure is as follows.

That is, a vehicle seat is provided with a seat sliding mechanism (a) including a lower rail oriented in a first direction and an upper rail fitted into the lower rail for moving in the first direction, a seat structure (b) provided with a seat cushion frame including a seat side member oriented in the first direction and a seat back frame connected to the seat cushion frame via a recliner, an upper riser (c) fixed to the upper rail for supporting the seat structure, and a seat inclining mechanism (d) that enables inclining of the seat structure for the upper riser. When the seat structure is inclined by the seat inclining mechanism, an angle between the seat cushion frame and the seat back frame is maintained and the rear of the seat cushion frame is located on the upside of the rear of the seat cushion frame before the seat structure is inclined by the seat inclining mechanism.

### BRIEF DESCRIPTION OF THE DRAWINGS

FIG. 1 is a side view showing the inside of a vehicle in a first embodiment;

FIG. 2 is a side view for explaining an outline of a seat inclining mechanism for inclining a second-row seat shown in FIG. 1;

FIG. 3 is a perspective view showing a seat structure of the second-row seat shown in FIG. 1 and viewed from the front side;

FIG. 4 is a top view showing the seat structure shown in FIG. 3;

FIG. 5 is a perspective view showing the seat structure shown in FIG. 3 and viewed from the back side;

FIG. 6 is a side view showing the seat structure shown in FIG. 3;

FIG. 7A is a perspective view showing the inside of a rotary latch and FIG. 7B is a perspective view showing the outside of the rotary latch;

FIG. 8 is a side view showing a state in which the seat structure is moved forward from a position shown in FIG. 6;

FIG. 9 is a side view showing a state in which the seat structure is turned forward from a position shown in FIG. 8;

FIG. 10 a perspective view showing the seat structure in a state shown in FIG. 9 and viewed from the back side;

FIG. 11 is a side view showing the inside of a vehicle in a second embodiment;

FIG. 12 is a side view for explaining an outline of a seat inclining mechanism for inclining a second-row seat shown in FIG. 11;

FIG. 13 is a perspective view showing a seat structure of the second-row seat shown in FIG. 11 and viewed from the front side;

FIG. 14 is a perspective view showing a state in which the seat structure shown in FIG. 13 is inclined and viewed from the back side;

FIG. 15 is a perspective view showing the seat structure shown in FIG. 14 and viewed from the back side;

FIG. 16 is a perspective view showing the seat structure shown in FIG. 14 and viewed from the back side;

FIG. 17 explains relation between a front side link mechanism and a back side link mechanism of the second-row seat shown in FIG. 13;

FIG. 18 is a side view showing the seat structure of the second-row seat shown in FIG. 13; and

FIG. 19 is a side view showing a state in which the seat structure is moved forward from a position shown in FIG. 17 and is inclined.

### DESCRIPTION OF THE PREFERRED EMBODIMENTS

In a vehicle such as a van and a sport utility vehicle (SUV), three or more-row seats are arranged in a longitudinal direction. For example, when a vehicle is provided with three-row seats, access to the third-row seat may be partially obstructed by the second-row seat depending upon a position of an opening of a door. Accordingly, it is performed to secure a large passage in front of the third-row seat by moving the second-row seat. That is, the second-row seat is slidable forward and its seat back can be forward leaned. When the seat back is forward leaned and the second-row seat is moved in a forward position, accessibility of an occupant to the third-row seat can be enhanced.

However, as a forward lean of the seat back is obstructed when a child safety seat and others exist on the second-row seat, accessibility to the third-row seat is also deteriorated.

Then, a vehicle seat equivalent to an embodiment is slidable forward and can be forward inclined in a state in which an angle between a seat cushion and a seat back is maintained. In this case, when the vehicle seat is forward inclined, the rear of the seat cushion is lifted. Hereby, space at the back of the vehicle seat can be extended.

A few embodiments will be described using the drawings below. However, in the following description, the same reference numeral is allocated to the same component and its repeated description may be omitted. To further clarify explanation by the drawings, the drawings may be schematically represented as to width, thickness, a contour and others of each part, compared with actual situations; however, they are one example to the end and the present invention is not limited to their interpretation.

In the following description, a perpendicular direction is defined as a vertical direction using a case that a vehicle mounting vehicle seats is located horizontally for a criterion. In addition, a longitudinal direction (FR, RR) is defined as a longitudinal direction of the vehicle and a lateral direction (a width direction) is defined as a vehicle width direction. FR denotes a forward direction of the vehicle and RR denotes a backward direction of the vehicle. Moreover, the right side (RH) and the left side (LH) of the vehicle seat shall be those when the vehicle seat is viewed from the back of the vehicle.

### First Embodiment

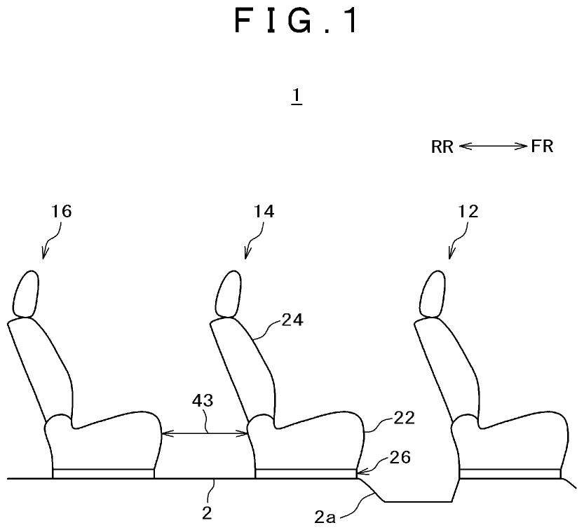

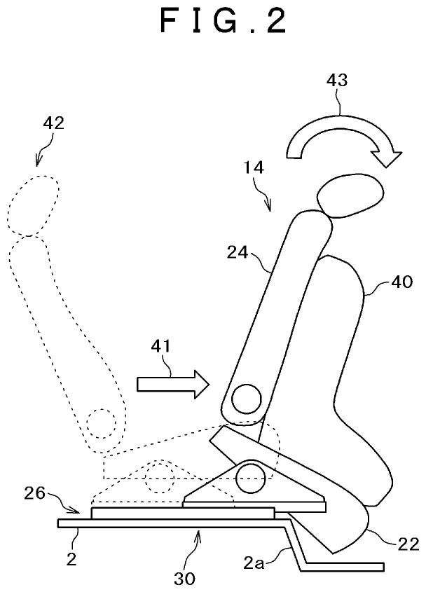

FIG. 1 is a side view showing the inside of a vehicle equivalent to a first embodiment. FIG. 2 is a side view explaining an outline of a seat inclining mechanism provided to a second-row seat shown in FIG. 1.

A first-row seat 12, the second-row seat 14 and a third-row seat 16 are arranged in order on a floor 2 of a vehicle 1 from the front toward the back. A level different part 2a turned lower toward the front is formed in front of an area in which the second-row seat 14 is arranged of the floor 2. Each row is provided with plural seats; however, the seats on the right side of the vehicle will be described below.

The second-row seat 14 is provided with a seat cushion 22 and a seat back 24 connected to the back side of the seat cushion 22.

In addition, as shown in FIG. 2, the second-row seat 14 is provided with a seat sliding mechanism 26 for moving the seat cushion 22 and the seat back 24 in a longitudinal direction and the seat inclining mechanism 30 for enabling turning the seat cushion 22 and the seat back 24 around a lateral shaft of the vehicle 1. Moreover, the seat inclining mechanism 30 maintains an angle between the seat cushion 22 and the seat back 24 in the turning. In such a configuration, even if a child safety seat 40 and others exist on the second-row seat 14, the second-row seat 14 can be inclined forward and can be moved in the longitudinal direction by the seat sliding mechanism 26. Though the child safety seat 40 exists on the second-row seat 14, space at the back of the second-row seat 14 can be extended owing to combination of a forward inclination and forward movement of the second-row seat 14 and for example, an occupant on the third-row seat can easily get in/out.

As shown in FIG. 2, the second-row seat 14 is moved forward 41 and is turned forward from an initial position 42 to a position shown in FIG. 2. For example, to access to the third-row seat 16, an occupant of the vehicle operates a release mechanism (a towel bar, others and a release lever described later) of the second-row seat 14. Hereby, the second-row seat 14 is moved forward 41 and can be turned in the direction 43. As a result, as size of an area between the second-row seat 14 and the third-row seat 16 increases, access to the third-row seat 16 is accelerated. Further, as an angle between the seat back 24 and the seat cushion 22 is substantially maintained when the second-row seat 14 is turned, the seat inclining mechanism can enhance accessibility to the third-row seat 16 by extending the space at the back of the second-row seat 14 independent of existence of the child safety seat 40. As the second-row seat 14 can be turned and moved to the initial position 42 when an occupant is seated on the third-row seat 16, comfort of an occupant on the second-row seat 14 is kept.

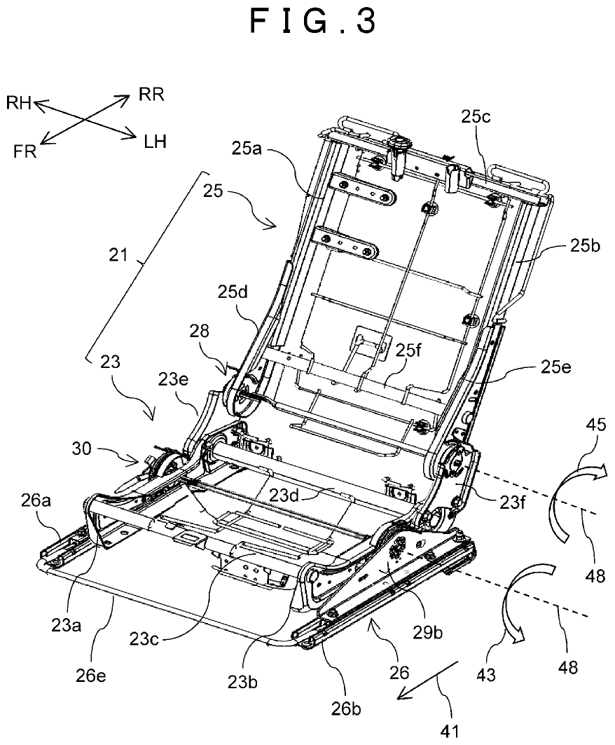

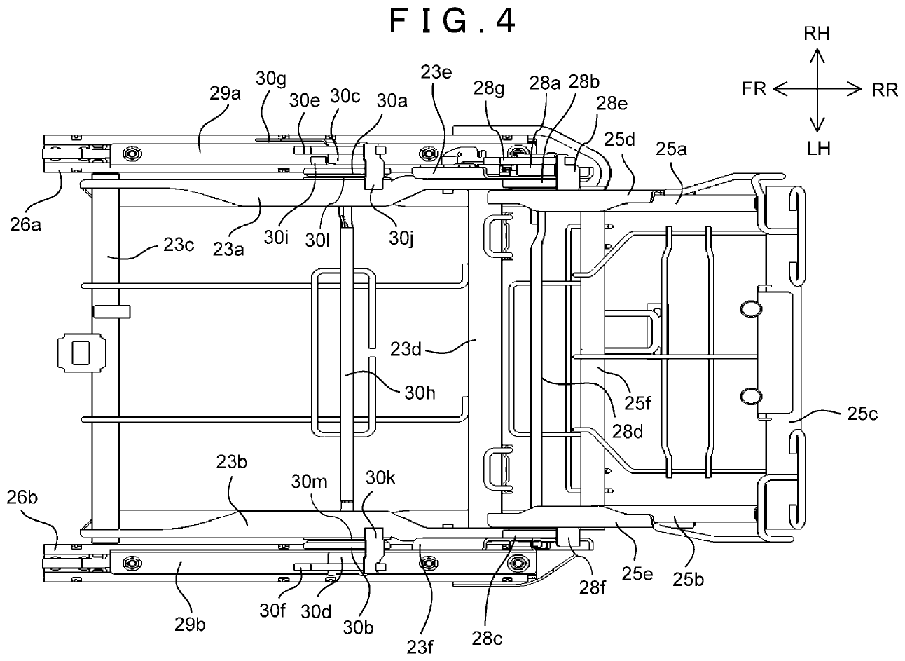

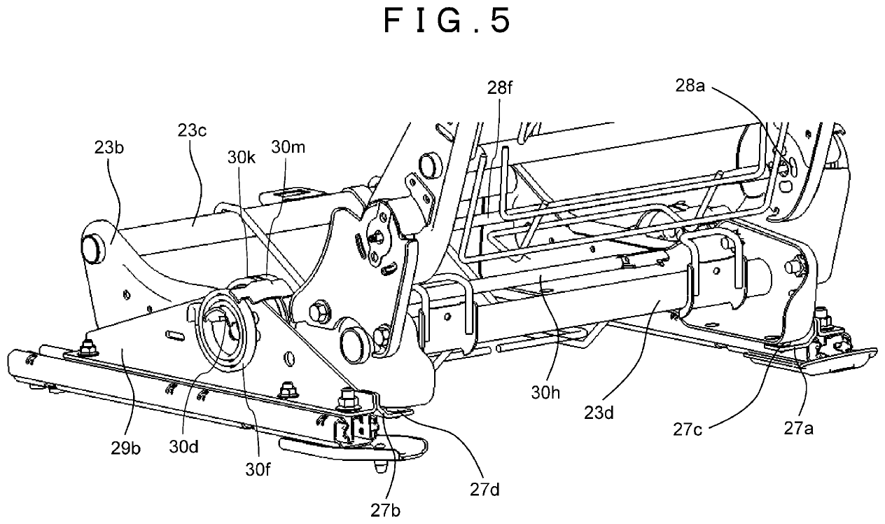

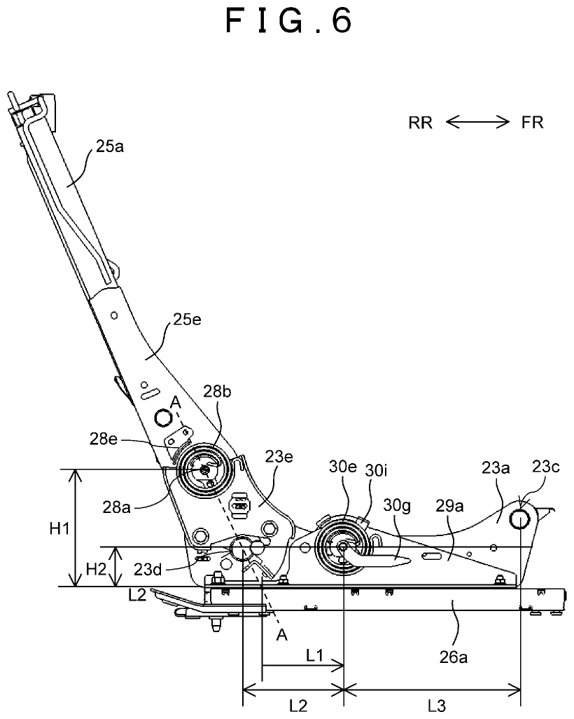

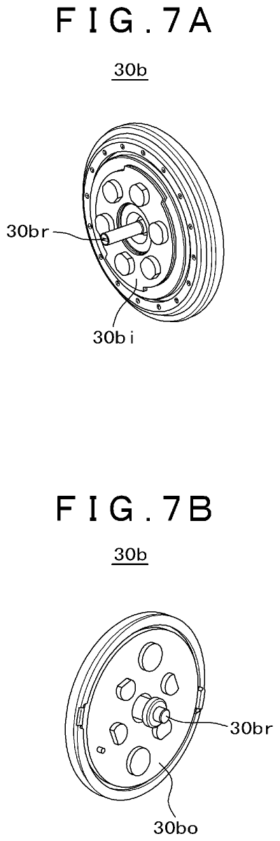

Next, the seat structure will be described referring to FIGS. 3 to 6. FIG. 3 is a perspective view showing the seat structure of the second-row seat shown in FIG. 1 and viewed from the front side. FIG. 4 is a top view showing the seat structure shown in FIG. 3. FIG. 5 is a perspective view showing the seat structure shown in FIG. 3 and viewed from the back side. FIG. 6 is a side view showing the seat structure shown in FIG. 3. FIG. 7A is a perspective view showing the inside of a rotary latch. FIG. 7B is a perspective view showing the outside of the rotary latch.

The seat structure 21 of the second-row seat 14 is provided with a seat cushion frame 23 and a seat back frame 25, and the frames are attached to the seat sliding mechanism 26. The seat sliding mechanism 26 enables movement in the longitudinal direction along a forward direction 41 of the seat structure 21. The seat inclining mechanism 30 enables turning based upon the seat sliding mechanism 26 of the seat structure 21.

The seat cushion 22 includes the seat cushion frame 23, a cushion and a cover. The seat back 24 also has the similar configuration and is configured by a cushion fixed by the seat back frame 25 and wrapped in a cover.

The seat cushion frame 23 is provided with seat side members 23a, 23b, a front cross member 23c connected to the front sides of the seat side members 23a, 23b, a back cross member 23d connected to the back sides of the seat side members 23a, 23b and recliner brackets 23e, 23f connected to the back sides of the seat side members 23a, 23b.

The seat back frame 25 is provided with back vertical pipes 25a, 25b, an upper cross member 25c connected to the upsides of the back vertical pipes 25a, 25b, brackets 25d, 25e connected to the downsides of the back vertical pipes 25a, 25b and a lower cross member 25f connected to the brackets 25d, 25e.

The seat structure 21 is provided with a recliner mechanism 28 for turning the seat back frame 25 on the basis of the seat cushion frame 23. Accordingly, the seat back frame 25 is supported by the recliner brackets 23e, 23f equipped with the recliner mechanism 28. The recliner mechanism 28 is provided with a recliner 28a attached to the recliner bracket 23e, recliner assist springs 28b, 28c, a recliner connection rod 28d and attachment brackets 28e, 28f attached to the brackets 25d, 25e. The recliner mechanism 28 enables turning the seat back frame 25 in a backward direction 45 around the lateral shaft 48.

The second-row seat 14 includes upper risers 29a, 29b for supporting the seat cushion frame 23. The upper risers 29a, 29b are in the shape of a triangle having an obtuse-angled apex in a side view and the seat inclining mechanism 30 is located on the side of each apex. The base sides of the upper risers 29a, 29b are fastened to upper rails 26c 26d of the seat sliding mechanism 26 by a bolt and others being a fixing member.

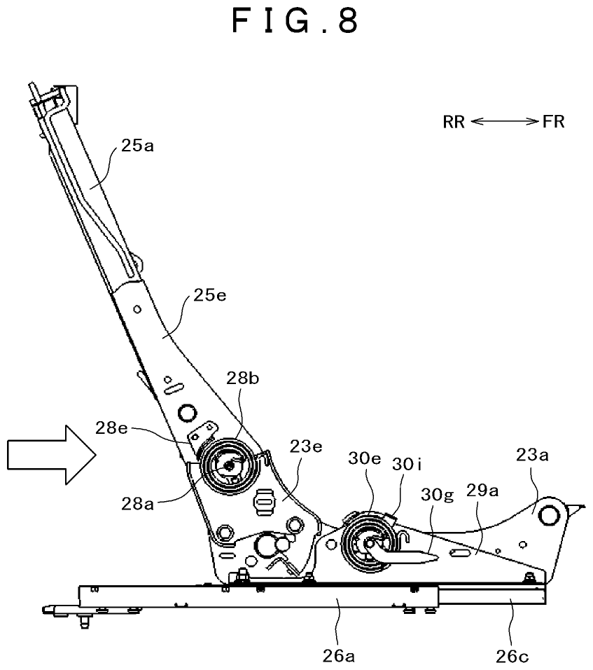

The seat sliding mechanism 26 includes a pair of lower rails 26a, 26b, the corresponding upper rails 26c, 26d (see FIGS. 8 to 10), a towel bar 26e and an operating part. The upper rail 26c, 26d is fitted into the corresponding lower rail 26a, 26b and is moved in a longitudinal direction 41. The seat sliding mechanism 26 includes stopper pins fitted to each upper rail 26c, 26d in an opening in the corresponding lower rail 26a, 26b. Hereby, longitudinal movement of the seat structure 21 is blocked. When an occupant turns the towel bar 26e so as to move the seat structure 21, fitting of the stopper pins is released from the opening and movement of the upper rail 26c, 26d from the corresponding lower rail 26a, 26b is enabled. Operability is more enhanced by providing the operating part for releasing locking of the seat sliding mechanism 26 to a lateral side or at the back of the seat back 24.

The seat inclining mechanism 30 is provided with the rotary latches 30a, 30b, auxiliary spring brackets 30c, 30d, auxiliary springs 30e, 30f, the release lever 30g, a turning connection rod 30h, a pivot stopper bracket 30i, attachment brackets 30j, 30k for fitting each outer end of the auxiliary springs 30e, 30f and attachment brackets 30l, 30m for fitting each rotary latch 30a, 30b.

The rotary latch 30a, 30b is the similar mechanism as the recliner and when the rotary latch is respectively fixed to the seat side member 23a, 23b, the rotary latch is respectively attached between the attachment bracket 30l, 30m and the upper riser 29a, 29b.

As shown in FIGS. 7A, 7B, the rotary latch 30b is provided with an inner rotor 30bi fixed to the attachment bracket 30m and an outer rotor 30bo fixed to the upper riser 29b. The rotary latch 30a is also similar. Normally, the rotary latch 30a is locked and its inner rotor is unturned against its outer rotor. When the release lever 30g of the rotary latch 30a is operated, locking is released and the inner rotor is made turnable for the outer rotor. A rod of the rotary latch 30a and a rod 30br of the rotary latch 30b are connected via the turning connection rod 30h and are interlocked. The turning connection rod 30h is arranged between the front cross member 23c and the back cross member 23d.

The auxiliary spring bracket 30c, 30d is attached to the outside of the corresponding upper riser 29a, 29b. An inner end of the auxiliary spring 30e, 30f is attached to the corresponding auxiliary spring bracket 30c, 30d. The attachment bracket 30j, 30k is fixed to the corresponding attachment bracket 30l, 30m. To apply pressure for forward turning to the seat side member 23a, 23b, an outer end of the auxiliary spring 30e, 30f is turned backward and the outer end is attached to the attachment bracket 30j, 30k. The auxiliary spring 30e, 30f in the drawings shows a state that its outer end is not attached yet.

A stopper bracket 27a, 27b for limiting turning when the seat structure 21 is turned backward is attached to the corresponding upper riser 29a, 29b. The stopper bracket 27a, 27b is respectively provided with a rubber bush 27c, 27d in a location on which the seat side member 23a, 23b abuts.

In the seat inclining mechanism 30, the seat side member 23a, 23b is respectively turnably connected to the upper riser 29a, 29b. As a result, the seat structure 21 can be turned in the forward direction 43 around the lateral shaft 48.

As shown in FIG. 6, the seat inclining mechanism 30 (the turning connection rod 30h which is a driving shaft of the seat inclining mechanism 30) is arranged in front (L1>0) of a location where a line (a line A-A) tying the center of a side of the recliner 28 and the center of a side of the back cross member 23d and a plane including a bottom of the upper riser 29a (a top face of the upper rail 26c) cross. When the seat inclining mechanism 30 is arranged in the vicinity of the front of each seat side member 23a, 23b, the distance from the center of gravity of the seat structure 21 increases and large force is required to turn the seat structure 21. When the seat inclining mechanism 30 is arranged in the vicinity of the rear of each seat side member 23a, 23b, the distance from the driving shaft to a front end of each seat side member 23a, 23b is extended and the level different part 2a of the floor 2 in front of the seat 14 is required to be extended. Therefore, it is desirable that the seat inclining mechanism 30 is arranged slightly at the back of the center in a longitudinal direction of each seat side member 23a, 23b. When the distance between the center of a side of the back cross member 23d and the center of turning of the seat inclining mechanism 30 is L2 and the distance between the center of a side of the front cross member 23c and the center of the turning of the seat inclining mechanism 30 is L3, it is desirable that (L2+L3)/3<L2<(L2+L3)/2 for example.

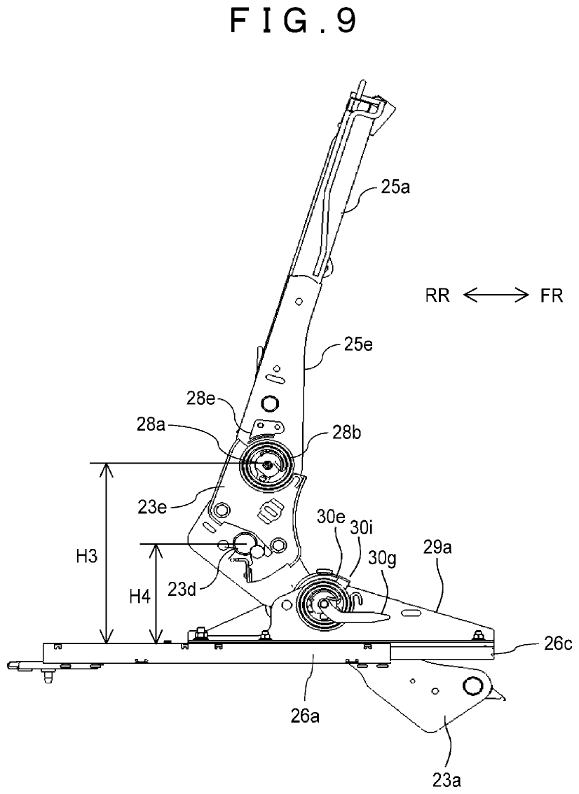

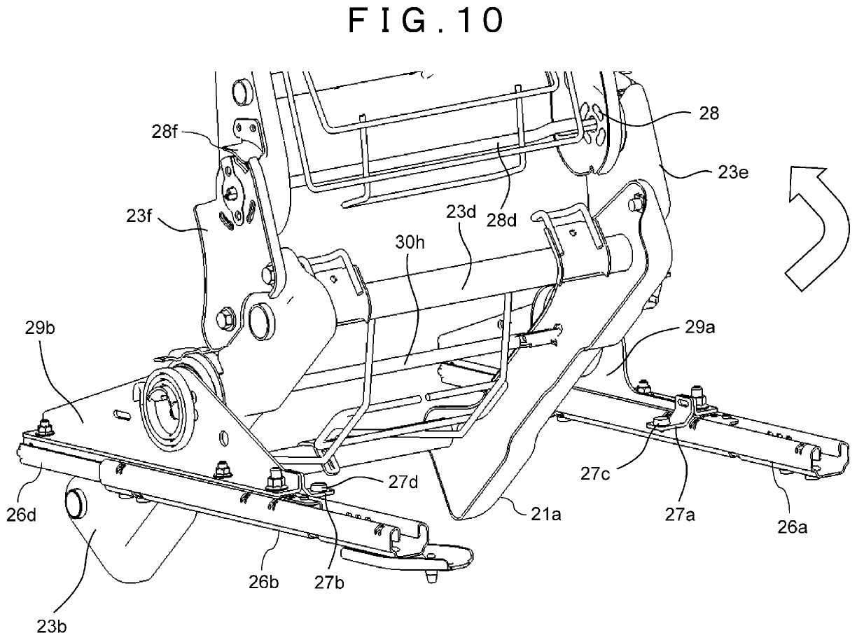

Next, operation of the seat structure will be described referring to FIGS. 8 to 10. FIG. 8 is a side view showing a state in which the seat structure is moved forward from a position shown in FIG. 6. FIG. 9 is a side view showing a state in which the seat structure is moved forward from a position shown in FIG. 8. FIG. 10 is a perspective view showing the seat structure in the state shown in FIG. 9 and viewed from the back side.

In an initial state shown in FIG. 6, the seat structure 21 is located in an erect position in which a bottom of each seat side member 23a, 23b is parallel to the top face of each upper rail 26c, 26d. In this case, the seat back frame 25 is not inclined backward by the recliner 28. When an occupant operates the towel bar 26e, locking of the upper rail 26c, 26d for the corresponding lower rail 26a, 26b is released and as shown in FIG. 8, the seat structure 21 is moved forward when the occupant presses the seat. For example, the moved distance is approximately 300 mm. When the occupant releases the towel bar 26e, the upper rail 26c, 26d is locked in the corresponding lower rail 26a, 26b.

When the occupant operates the release lever 30g of the rotary latch 30a, locking of the seat side member 23a, 23b for the corresponding upper riser 29a, 29b is released, the seat structure 21 is turned forward to an inclined position shown in FIG. 9 by pressure of the auxiliary springs 30e, 30f, and when the occupant releases the release lever 30g, the rotary latch 30a locks and fixes the seat structure 21. In this case, a bottom of the front of the seat side member 23a is located on the downside of a bottom of the lower rail 26a and a top face of the front of the seat side member 23a is also located on the downside of the bottom of the lower rail 26a.

When the height from a top face of the lower rail 26a to the center of the recliner 28a is H1 and the height to the center of the back cross member 23d is H2 in a case that the seat structure 21 is located in the erect position as shown in FIG. 6, the height from the top face of the lower rail 26a to the center of the recliner 28a is H3 and the height to the center of the back cross member 23d is H4 in a case that the seat structure is located in the inclined position as shown in FIG. 9, H1<H3 and H2<H4.

In this embodiment, the seat structure 21 is turned by approximately 50 degrees from the erect position shown in FIG. 8. Turning when the child safety seat 40 is installed on the seat 14 is approximately 20 degrees for example. The turning may also be turning at a larger or smaller angle than this. At this time, an angle between the seat cushion frame 23 and the seat back frame 25 is maintained. The turning at a large angle accelerates enhancement of accessibility to the third-row seat 16 and in the meantime, the turning can house the child safety seat 40.

When the occupant operates the release lever 30g and pulls the second-row seat 14 backward after the occupant is seated on the third-row seat 16, the seat structure 21 is turned backward to return to the erect position shown in FIG. 8, the seat structure abuts on the rubber bushes 27c, 27d of the stopper brackets 27a, 27b, and the seat structure is stopped. When the occupant releases the release lever 30g, the rotary latch 30a is locked and the seat structure 21 is fixed. Afterward, when the occupant operates the operating part of the seat sliding mechanism 26 or the towel bar 26e and pulls the second-row seat 14 backward, the second-row seat is moved backward and is returned to the initial position shown in FIG. 6.

### Second Embodiment

In the following description of a second embodiment, the similar reference numeral to that in the abovementioned embodiment shall be used for a part having the similar configuration and the similar function to that described in the abovementioned embodiment. In the description of such a part, the description in the abovementioned embodiment can be suitably cited in a technically consistent range. In addition, a part of the abovementioned embodiment can be suitably complexly applied in the technically consistent range.

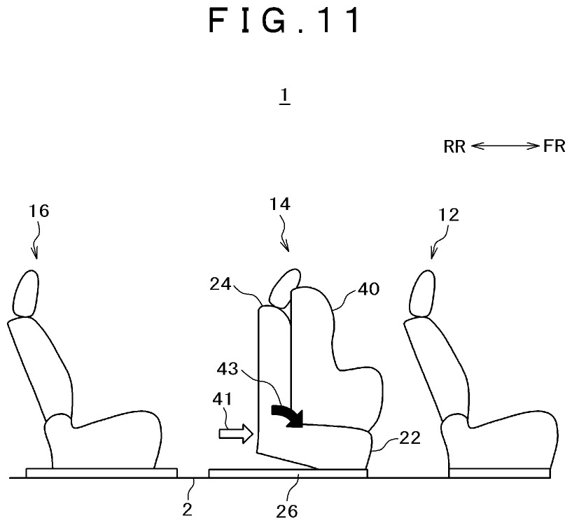

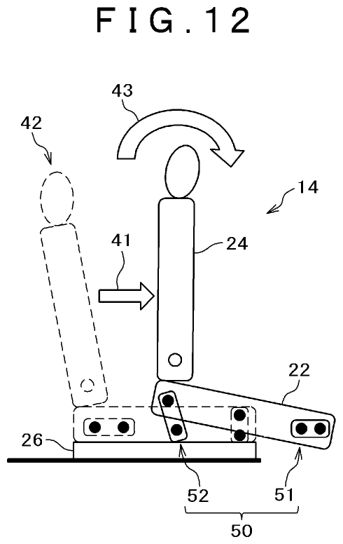

FIG. 11 is a side view showing the inside of a vehicle in the second embodiment. FIG. 12 is a side view explaining an outline of a seat inclining mechanism of a second-row seat shown in FIG. 11.

As shown in FIG. 11, as in the first embodiment, a first-row seat 12, the second-row seat 14 and a third-row seat 16 are arranged on a floor 2 of the vehicle 1 in order from the front side toward the back side. Each row is provided with plural seats; however, in the following, the seats on the right side of the vehicle will be described.

As shown in FIG. 12, the second-row seat 14 in the second embodiment is provided with a seat cushion 22 and a seat back 24 connected to the seat cushion 22. In addition, the second-row seat 14 is provided with a seat sliding mechanism 26 for moving the seat cushion 22 and the seat back 24 in a longitudinal direction and a seat inclining mechanism 50 that enables forward inclination of the seat cushion 22 and the seat back 24. The seat inclining mechanism 50 is provided with a front side link mechanism 51 for moving the seat cushion 22 and the seat back 24 in the longitudinal direction and a back side link mechanism 52 for vertically rocking them. Moreover, the seat inclining mechanism 50 maintains an angle between the seat cushion 22 and the seat back 24 during the forward inclination. In such a configuration, as in the first embodiment, even if a child safety seat 40 and others exist on the second-row seat 14, the second-row seat 14 can also be inclined forward and can also be moved in the longitudinal direction by the seat sliding mechanism 26. Hereby, the similar effects to those in the first embodiment are produced.

As shown in FIG. 12, the second-row seat 14 is moved in a forward direction 41 by the seat sliding mechanism 26 and is inclined forward from an initial position 42 to a position shown in FIG. 12 by the seat inclining mechanism 50. To access to the third-row seat 16 as in the first embodiment, an occupant operates a release mechanism (a towel bar, others and a release lever respectively described later) of the second-row seat 14. Hereby, the second-row seat 14 is moved in the forward direction 41 and can be inclined in a direction 43. As a result, as size of an area between the second-row seat 14 and the third-row seat 16 increases, access to the third-row seat 16 is accelerated. Further, as an angle between the seat back 24 and the seat cushion 22 is substantially maintained when the second-row seat 14 is inclined, the seat inclining mechanism 50 can enhance accessibility to the third-row seat 16 by extending space at the back of the second-row seat 14 independent of existence of the child safety seat 40. As the second-row seat 14 can be rocked and moved to return to the initial position 42 when the occupant is seated on the third-row seat 16, comfort of an occupant on the second-row seat 14 is kept.

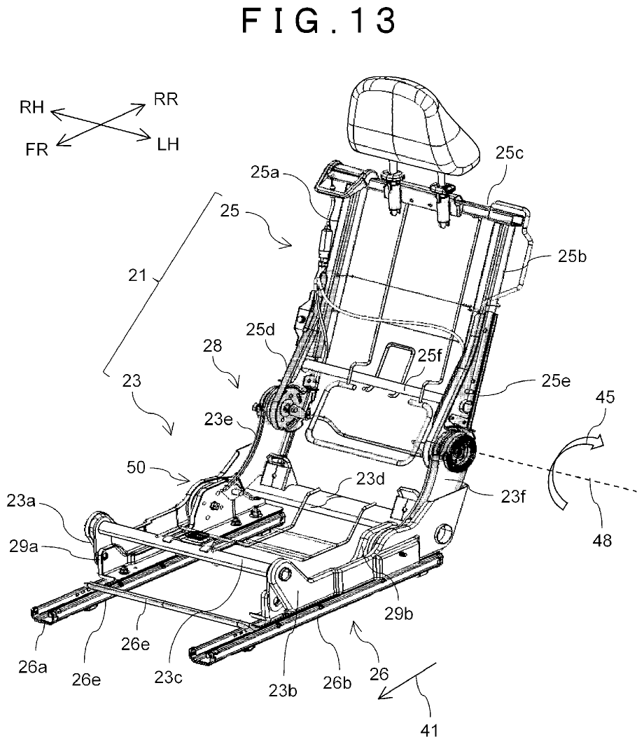

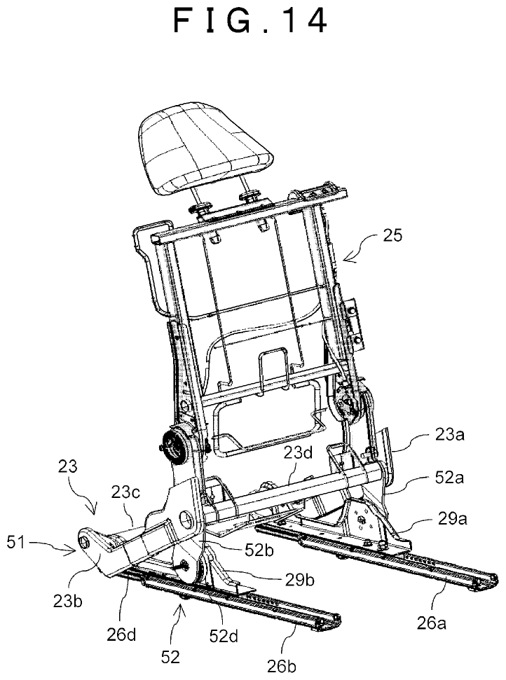

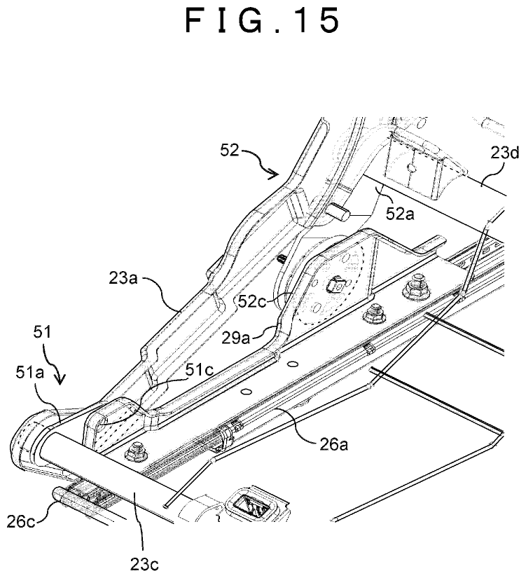

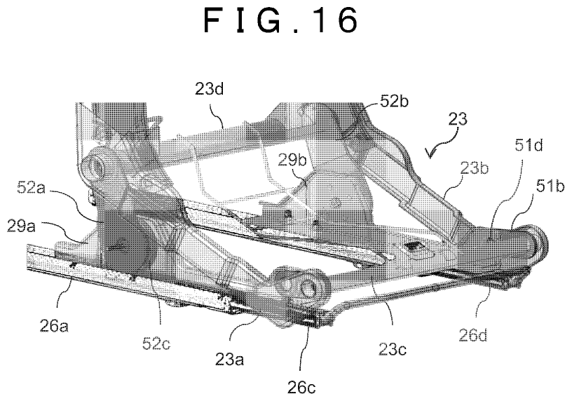

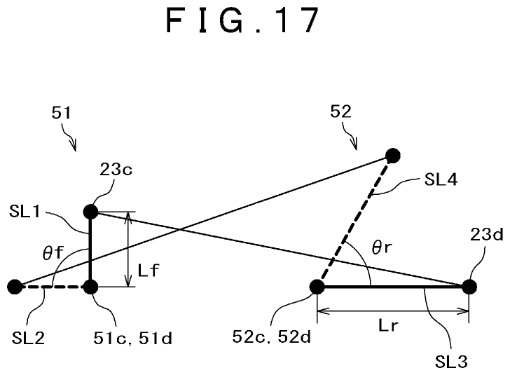

Next, the seat structure will be described referring to FIGS. 13 to 17. FIG. 13 is a perspective view showing the seat structure of the second-row seat shown in FIG. 11 and viewed from the front side. FIG. 14 is a perspective view showing a state in which the seat structure shown in FIG. 13 is inclined and viewed from the back side. FIG. 15 is a perspective view showing the seat structure shown in FIG. 14 and viewed from the front side. FIG. 16 is a perspective view showing the seat structure shown in FIG. 14 and viewed from the front side. FIG. 17 explains relation between the front side link mechanism and the back side link mechanism of the second-row seat shown in FIG. 13.

The seat structure 21 of the second-row seat 14 is provided with a seat cushion frame 23 and a seat back frame 25, and the seat structure is attached to the seat sliding mechanism 26. The seat sliding mechanism 26 enables movement in the longitudinal direction along the forward direction 41 of the seat structure 21. The seat inclining mechanism 50 enables rocking the seat structure 21 along the seat sliding mechanism 26.

The seat cushion 22 includes the seat cushion frame 23, a cushion and a cover. The seat back 24 also has the similar configuration and is configured by a cushion fixed to the seat back frame 25 and wrapped in a cover.

The seat cushion frame 23 is provided with seat side members 23a, 23b, a front cross member 23c connected to the front sides of the seat side members 23a, 23b, a back cross member 23d connected to the back sides of the seat side members 23a, 23b, and recliner brackets 23e, 23f connected to the back sides of the seat side members 23a, 23b as in the first embodiment.

The seat back frame 25 is provided with back vertical pipes 25a, 25b, an upper cross member 25c connected to the upsides of the back vertical pipes 25a, 25b, brackets 25d, 25e connected to the downsides of the back vertical pipes 25a, 25b and a lower cross member 25f connected to the brackets 25d, 25e as in the first embodiment.

The seat structure 21 is provided with a recliner mechanism 28 for turning the seat back frame 25 on the basis of the seat cushion frame 23. A configuration and operation of the recliner mechanism 28 are similar to those in the first embodiment.

The second-row seat 14 includes upper risers 29a, 29b for supporting the seat cushion frame 23 as in the first embodiment. The bottom side of the upper riser 29a, 29b is respectively fastened to an upper rail 26c, 26d of the seat sliding mechanism 26 by a bolt and others which are a fixing member. A configuration and operation of the seat sliding mechanism 26 are similar to those in the first embodiment.

As shown in FIGS. 14 to 16, the seat structure 21 is coupled to the upper risers 29a, 29b by the front side link mechanism 51 and the back side link mechanism 52. The front side link mechanism 51 is provided with two links of a link 51a provided on the right front side of the seat cushion frame 23 and a link 51b provided on the left front side. Further, one end side of the link 51a, 51b is turnably connected to the corresponding upper riser 29a, 29b by a stem 51c, 51d and in the meantime, and the other end side of the link 51a, 51b is turnably connected to a front cross member 23c of the seat cushion frame 23. Axes of the turning shafts of each link 51a, 51b are equivalent to a vehicle width direction.

The back side link mechanism 52 is provided with two links of a link 52a provided on the right back side of the seat cushion frame 23 and a link 52b provided on the left back side. Further, one end side of the link 52a, 52b is turnably connected to the corresponding upper riser 29a, 29b by the corresponding rotary latch 52c, 52d which is a shank and in the meantime, the other end side of the link 52a, 52b is turnably connected by a back cross member 23d of the seat cushion frame 23. Axes of the turning shafts of each link 52a, 52b are equivalent to the vehicle width direction.

The rotary latch 52c, 52d is the similar mechanism to the rotary latch 30a, 30b in the first embodiment and is attached between the corresponding link 52a, 52b and the corresponding upper riser 29a, 29b. To apply forward rotary pressure to the seat side member 23a, 23b, the similar auxiliary spring (not shown) to that in the first embodiment is attached.

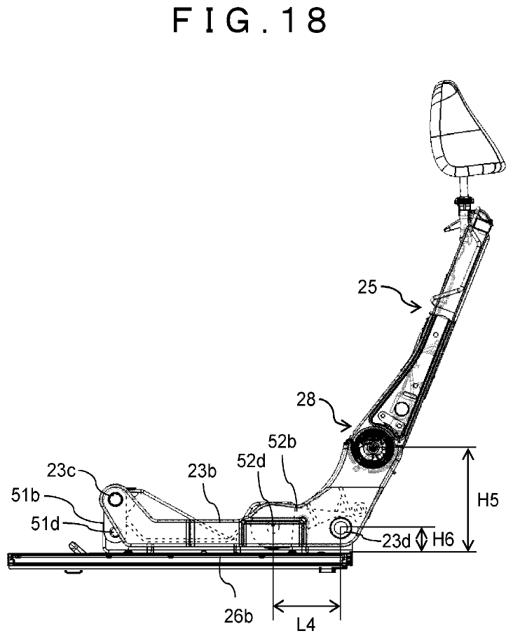

As shown in FIG. 17, an angle between a straight line SL1 tying the center of the corresponding stem 51c, 51d of the link 51a, 51b when the seat structure 21 is located in an erect position shown in FIG. 13 and the center of the front cross member 23c and a straight line SL2 tying the center of the corresponding stem 51c, 51d of the link 51a, 51b when the seat structure 21 is located in an inclined position shown in FIG. 18 and the center of the front cross member 23c shall be θf. In addition, an angle between a straight line SL3 typing the center of the corresponding rotary latch 52c, 52d which is the shank of the link 52a, 52b when the seat structure 21 is located in the erect position shown in FIG. 13 and the center of the back cross member 23d and a straight line SL4 tying the center of the corresponding rotary latch 52c, 52d which is the shank of the link 52a, 52b when the seat structure 21 is located in an inclined position shown in FIG. 14 and the center of the back cross member 23d shall be θr. Moreover, each length of the straight lines SL1, SL2 shall be Lf and each length of the straight lines SL3, SL4 shall be Lr. The front side link mechanism and the back side link mechanism have relation of “θf>θr, θf is approximately 90° and Lf<Lr”.

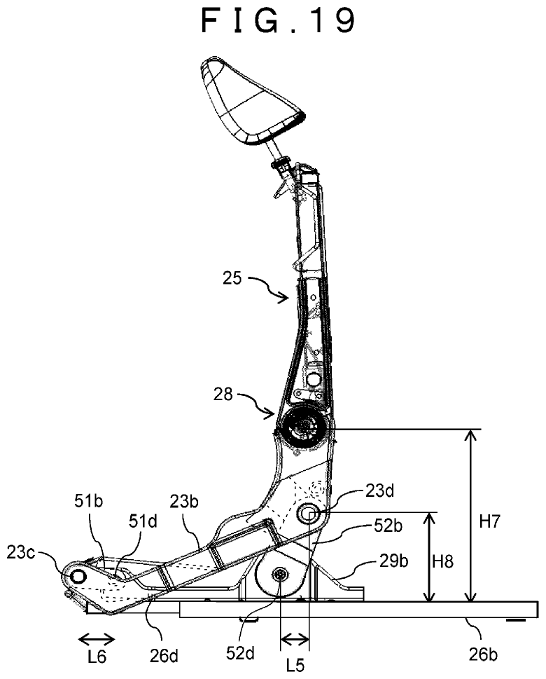

Next, operation of the seat structure will be described referring to FIGS. 18, 19. FIG. 18 is a side view showing the seat structure shown in FIG. 13. FIG. 19 is a side view showing a state in which the seat structure is moved forward from a position shown in FIG. 17 and is inclined.

In an initial position shown in FIG. 18, the seat structure 21 is located in the erect position in which the corresponding bottom of the seat side member 23a, 23b is parallel to a top face of the corresponding upper rail 26a, 26b. In this case, the seat back frame 25 is not inclined backward by a recliner 28. The link 51a, 51b in the erect position of the seat structure 21 is oriented in a substantially perpendicular direction shown by a line tying the center of the front cross member 23c and the center of the stem 51c in a side view. The link 52a, 52b in the erect position of the seat structure 21 is oriented in a substantially horizontal direction shown by a line tying the center of the back cross member 23d and the center of the corresponding rotary latch 52c, 52d in the side view. The longitudinal distance between the center of the back cross member 23d and the center of the rotary latch 52c, 52d shall be L4. When an occupant operates a towel bar 26e, locking of the upper rail 26c, 26d for the corresponding lower rail 26a, 26b is released as in the first embodiment and the seat structure 21 is moved forward when the occupant presses the seat. When the occupant releases the towel bar 26e, the upper rail 26c, 26d is locked in the corresponding lower rail 26a, 26b.

When the occupant operates a release lever (not shown) of the rotary latch 52c, locking of the link 52a, 52b for the corresponding upper riser 29a, 29b is released, the seat structure 21 is inclined forward by pressure of an auxiliary spring (not shown), the seat structure is inclined to an inclined position shown in FIG. 19, the rotary latch 52c locks the seat structure, and the seat structure 21 is fixed. The back cross member 23d is rocked upward and the front cross member 23c is rocked forward. When the longitudinal distance between the center of the back cross member 23d and the center of the rotary latch 52c, 52d in the side view is L5, L5<L4 and L4 is approximately Lr. In addition, when the longitudinal distance between the center of the front cross member 23c and the center of the stem 51c, 51d is L6, L6 is substantially 0, is the smallest in the erect position shown in FIG. 18, and L6 is the longest in the inclined position shown in FIG. 19.

When the height from the top face of the upper rail 26a to the center of the recliner 28 is H5 and the height from the top face of the upper rail to the center of the back cross member 23d is H6 in a case that the seat structure 21 is located in the erect position as shown in FIG. 18, the height from the top face of the upper rail 26a to the center of the recliner 28 is H7 and the height from the top face of the upper rail to the center of the back cross member 23d is H8 in a case that the seat structure is located in the inclined position as shown in FIG. 19, H5<H7 and H6<H8.

In this case, a bottom of the front of the seat side member 23a, 23b is located lower than the top face of the corresponding upper rail 26c, 26d. In addition, the bottom of the front of the seat side member is located higher than a bottom of the corresponding lower rail 26a, 26b. Hereby, as in the second embodiment, even if no level different part exists in front of the second-row seat 14, the seat structure 21 can be inclined. At this time, an angle between the seat cushion frame 23 and the seat back frame 25 is maintained. An inclination of a large angle accelerates enhancement of accessibility to the third-row seat 16 and in the meantime, the child safety seat 40 can be housed.

When an occupant is seated on the third-row seat 16, operates the release lever and pulls the second-row seat 14 backward, the seat structure 21 is rocked backward to return to the erect position shown in FIG. 18, the back cross member 23d abuts on the upper risers 29a, 29b, and the seat structure is stopped. When the occupant releases the release lever, the rotary latch 52c is locked and the seat structure 21 is fixed. Afterward, when the occupant operates an operating part of the seat sliding mechanism 26 or the towel bar 26e and pulls the second-row seat 14 backward, the second-row seat is moved backward and is returned to the initial position shown in FIG. 18.

The present invention made by these inventors has been described on the basis of the embodiments in the concrete; however, it need scarcely be said that the present invention is not limited to the abovementioned embodiments and can be varied.

For example, in the embodiments, the vehicle is provided with three-row seats; however, the vehicle may also be provided with more-row seats than three rows. In addition, when the vehicle is provided with two-row seats of a front row seat and a back row seat, a seat inclining mechanism may also be provided to the front row seat.

Moreover, in the embodiments, the example that the seat structure 21 is moved by operating the towel bar 26e is described; however, the seat structure 21 may also be moved by operating a sliding release lever via a cable.

In addition, in the embodiments, the example that the rotary latches 30a, 30b are interlocked by the turning connection rod 30h is described; however, the rotary latches 30a, 30b may also be interlocked by a lever and a cable.

What is claimed is:

1. A vehicle seat, comprising:
a seat sliding mechanism including a lower rail oriented in a first direction and an upper rail fitted into the lower rail and moved in the first direction;
a seat structure provided with a seat cushion frame including a seat side member oriented in the first direction and a seat back frame connected to the seat cushion frame by a recliner;
an upper riser fixed to the upper rail for supporting the seat structure; and
a seat inclining mechanism that enables inclining of the seat structure for the upper riser,
wherein when the seat structure is inclined by the seat inclining mechanism, an angle between the seat cushion frame and the seat back frame is maintained and the rear of the seat cushion frame is located on the upside of the rear of the seat cushion frame in a state before the seat structure is inclined by the seat inclining mechanism.

2. The vehicle seat according to claim 1,
wherein the seat inclining mechanism turnably connects the seat side member to the upper riser.

3. The vehicle seat according to claim 2,
wherein the seat inclining mechanism holds the seat structure in a first position; and
the seat inclining mechanism can turn the seat structure between the first position and a second position.

4. The vehicle seat according to claim 2,
wherein the seat side member is configured by a pair of seat side members;
the seat cushion frame is further provided with a front cross member connecting the fronts of the pair of seat side members and a back cross member connecting the rears of the pair of seat side members; and
the seat inclining mechanism is located between the front cross member and the back cross member.

5. The vehicle seat according to claim 4,
wherein the seat inclining mechanism is provided with a rotary latch between the seat side member and the upper riser; and
the rotary latch turnably connects the seat side member with the upper riser.

6. The vehicle seat according to claim 5,
wherein the seat inclining mechanism is provided with a spring for pressing the seat structure to turn the seat structure forward.

7. The vehicle seat according to claim 6,
wherein the upper riser is provided with a stopper for stopping backward turning of the seat structure.

8. The vehicle seat according to claim 4,
wherein a turning shaft of the seat inclining mechanism is located in a position distant from the back cross member by a distance equivalent to ⅓ to ½ of a distance between the back cross member and the front cross member.

9. The vehicle seat according to claim 1,
wherein the seat inclining mechanism links the seat side member to the upper riser.

10. The vehicle seat according to claim 9,
wherein the seat inclining mechanism holds the seat structure in the first position; and
the seat inclining mechanism enables inclining of the seat structure between the first position and a second position.

11. The vehicle seat according to claim 9,
wherein the seat side member is configured by a pair of seat side members;
the seat cushion frame is further provided with a front cross member connecting the fronts of the pair of seat side members and a back cross member connecting the rears of the pair of seat side members;
the seat inclining mechanism is provided with a front side link mechanism and a back side link mechanism;
the front side link mechanism is provided with a front side stem connecting the seat side member to the upper riser and a front side coupling part coupling the stem with the front cross member; and
the back side link mechanism is provided with a back side shank connecting the seat side member to the upper riser and a back side coupling part coupling the shank with the back cross member.

12. The vehicle seat according to claim 11,
wherein the front cross member is moved forward by the back side link mechanism; and
the back cross member is moved upward by the back side link mechanism.

13. The vehicle seat according to claim 11,
wherein the back side link mechanism is provided with a rotary latch between the seat side member and the upper riser; and
the rotary latch turnably connects the seat side member and the upper riser.
